(19) United States
(12) Patent Application Publication
(10) Pub. No.: US 2013/0055707 A1
(43) Pub. Date: Mar. 7, 2013

(54) DEVICE FOR RECOVERING SWELL ENERGY

(71) Applicant: Jose-Antonio Ruiz-Diez, Octreville Sur Mer (FR)

(72) Inventor: Jose-Antonio Ruiz-Diez, Octreville Sur Mer (FR)

(21) Appl. No.: 13/581,408

(22) PCT Filed: Feb. 24, 2011
(86) PCT No.: PCT/EP11/52725

§ 371 Date: Nov. 6, 2012

(30) Foreign Application Priority Data
Feb. 26, 2010 (FR) 10 51388

(51) Int. Cl. F03B 13/20

(52) U.S. Cl. 60/500

(57) ABSTRACT

The invention relates to a device for recovering the energy of sea waves comprised of a floating structure comprising:—a rigid structural element (1) maintained floating on the sea thanks to at least one buoy or floater referred to as structural (2, 2′), and—at least one mobile floater (3, 3′) with regards to the structural element and cooperating with a means of generating recoverable energy (4; 14, 15, 16) under the effect of the movement of the waves, said means (4; 14, 15, 16) being fixed to the structural element.

According to the invention, at least one mobile floater (3, 3′) is connected to the structural element by at least one rigid arm (5, 5′) mounted rotatingly around an axis substantially parallel to the surface of the sea and said means of generating energy (4; 14, 15, 16) is directly or indirectly linked to said rigid arm.

### TECHNICAL FIELD OF THE INVENTION

The invention relates to the field recovering energy and more particularly to the energy of the waves at sea.

Currently, energy consumption is primarily based on non-renewable energies such as oil, gas, coal and nuclear. In light of the depletion of the reserves of these energies and/or of the pollution that is generated in using them, it is sought to diversify the sources of energies, by turning in particular towards renewable energies.

In this context, one solution consists in using the energy coming from the sea, more precisely in terms of currents, waves or tides.

As such, the energy from waves is nothing less than a particular form of solar energy. The sun heats the different atmospheric layers unequally which causes air currents (winds) which are then responsible by friction for the movements which animate the surface of the sea (currents, waves). The waves created by the wind on the surface of the seas and oceans transport energy. When they arrive on a floating or coastal obstacle they can relinquish a portion of this energy which can be transformed into electric current. It is where the winds are the strongest, between 40° and 60° latitude, that the power of the waves is maximal.

Consequently, energy from waves has a very high potential of power. As such, the average power transported by the waves is given in kW per linear meter. It is proportional to the period of the waves (duration that separates the arrival of two successive wave crests) and to the square of the height of the wave (distance between the trough and the crest). For example this potential is 63 kW/m off the coast of Ouessant, an average of 50 kW/m on the Atlantic coast and 8 kW/m in the Mediterranean.

However, this total resource cannot be fully used in particular in light of the technical limitations and natural or legal limitations that reduce the domain that can be used.

### PRIOR ART

As such, EP 1 295 031 discloses a device based on the movement of a buoy, the device comprising an exterior round floater surrounding an interior floater, these two floaters being connected to one another by means of linking comprising in particular hydraulic cylinders making it possible to recover the energy of the movement between the two floaters and having furthermore an immersed body.

A mobile cylinder is also known (the floater) filled with air that slides on a cylinder fixed to the sea bottom. In the absence of waves the floater is balanced. When the top of the wave passes over the floater the overpressure drives the floater downwards. In the trough of the wave the depression cause the floater to go back up. The comings and goings of the floater in relation to the fixed cylinder causes a linear dynamo that produces electric current. This device however has the disadvantage of having to be fixed in part to the sea bottom.

It is further known in WO 2008/068390 a device for recovering the energy of the waves of which the structure is simple which facilitates the use and implementation of it. This device comprises at least one floating structure, intended to float on the surface of the water, which bears at least one member suspended above the surface of the water of which the structure is designed to generate a recoverable energy through the variation in height of the surface of the water in relation to said member, under the effect of the ascending and descending movement of the waves.

However in this system the recovering of energy is not optimal because there are instants (dead time) during which no energy is supplied by the system, when the suspended member is arranged at the end of travel. It is easily understood that these dead times limit the output of the system.

### DESCRIPTION OF THE INVENTION

The invention aims to overcome the disadvantages of prior art and in particular to propose a system capable of recovering energy from waves in a continuous manner, with furthermore an optimisation of the output.

For this is proposed a device for recovering the energy of sea waves comprised of a floating structure including:—a rigid structural element, maintained floating on the sea thanks to at least one buoy or floater referred to as structural, and at least one mobile floater with regards to the structural element and cooperating with a means of generating recoverable energy under the effect of the movement of the waves, said means being fixed on the structural element.

According to a first aspect of the invention, the at least one mobile floater is connected to the structural element by at least one rigid arm mounted rotatingly around an axis of the structural element substantially parallel to the surface of the sea, and said means of generating energy is linked directly or indirectly to said rigid arm.

Furthermore, according to an embodiment of the invention, the means of generating energy comprises a linear generator having a piston linked to at least one of said mobile floaters, and which slides in a cylinder linked to the structural element.

In accordance with another possibility, the means of generating energy comprise at least one pump having a cylinder and a rod, of which one end is articulated on a rigid arm of at least one of the mobile floaters, and of which the other end is linked to the structural element.

Those skilled in the art will choose one or the other of these alternatives according to the case, costs or skills that they have.

Advantageously, the device according to the invention can include several mobile floaters of which the link arms with the structural element have different lengths.

More preferably, and for reasons which shall be mentioned in more detail hereinafter, the shortest arm or arms shall be arranged “at the output” of the waves i.e. in the vicinity of the one end of the device placed opposite the end which directly received (frontally) the waves.

In accordance with an embodiment of the invention, at least one structural floater is fixed in relation to the structural element, arranged on the waterline in such a way that the structural element is mostly arranged above the surface of the sea.

If it is sought to further improve the energy output of the invention, it can be considered to provide at least one articulated structural floater in relation to the structural element.

More precisely, according to an embodiment of the invention at least one of said articulated structural floaters is arranged at one of the ends of a swinging arm linked to the structural element by at least one first articulation, said arm having at its other end a second articulation associated with the rod of a piston of a cylinder fixed on the structural element above the waterline, said piston being intended to actuate said means of generating energy.

According to another embodiment of the invention, at least one of said articulated structural floaters is passed through by a swinging arm linked to the structural element by two articulations the first arranged below the waterline consists of a pivot link, the second link comprises an articulation associated with the rod of a piston of a cylinder fixed on the structural element above the waterline, said piston being intended to actuate said means of generating energy.

Moreover, the structural element comprises at least one framework arranged according to a plane referred to as lateral and which cooperates with at least one structural floater and a mobile floater. The so-called lateral plane is a plane parallel to the direction of the waves, according to which the floating structure will be oriented to spontaneously.

Interestingly, the structural element can include two frameworks arranged according to first and second planes parallel to each other, said frameworks being connected together by at least one framework arranged according to at least one plane perpendicular to said first and second planes, with the whole defining substantially a parallelogram of which the surface arranged above the level of the sea is provided with means of support for the articulation or articulations, for the mobile floater or floaters and/or means of generating energy and/or structural floaters. Of course the “surface arranged above the level of the sea” has meaning only when the device is placed into situation i.e. when it is floating on the sea or in a medium generating waves.

Interestingly, the swinging arm of at least one of said structural floaters is mobile in said first and/or said second planes of the frameworks referred to as lateral plane.

According to an embodiment of the invention, at least one first rigid arm is mounted articulated on a first longitudinal end of the structural element and a second rigid arm is mounted articulated on a second longitudinal end of the structural element, said first and said second arm extending longitudinally outside of the structural element.

According to another characteristic of the invention, the structural element comprises an main element which extends according to an longitudinal axis XX; said structural floaters are arranged symmetrically with regards to the axis XX and said structural floaters bear, in a floating situation, structural arms belonging to the planes perpendicular or substantially perpendicular to the axis XX.

More precisely, at least one structural arm is mounted rotatingly around an axis YY perpendicular to the axis XX.

Furthermore at least one structural arm comprises a first element which extends substantially parallel to the surface of the sea, and a second element which extends substantially perpendicularly to the first element and which is borne by a structural floater in a floating situation.

According to an embodiment of the invention, a rotating link can be provided between the main element and at least one structural arm.

In accordance with another embodiment of the invention, a rotating link can be provided between the first and the second element of a structural arm and a means of generating energy then makes it possible to recover the energy generated by the relative movement between the first and the second element.

### BRIEF DESCRIPTION OF THE FIGURES

Other characteristics, details and advantages of the invention shall come from reading the following description, in reference to the annexed figures, which show:

FIG. 1, a diagrammatical and cross-section view of the device according to a first embodiment of the invention;

FIG. 2, a diagrammatical and cross-section view of the device according to a second embodiment of the invention;

FIG. 3 a diagrammatical and cross-section view of a third embodiment of the invention;

FIG. 4A is a cross-section according to AA in FIG. 3, for an embodiment of the invention;

FIG. 4B is a cross-section according to BB in FIG. 3, for an embodiment of the invention;

FIG. 5A is a cross-section according to AA in FIG. 3, for an alternative embodiment of the invention;

FIG. 5B is a cross-section according to BB in FIG. 3, for an alternative embodiment of the invention;

FIG. 6 a diagrammatical and cross-section view of a fourth embodiment of the invention;

FIG. 7A is a cross-section according to AA in FIG. 6, for this embodiment of the invention;

FIG. 7B is a cross-section according to BB in FIG. 6, for this embodiment of the invention;

FIG. 8A is a cross-section according to AA in FIG. 6, for the fourth embodiment of the invention;

FIG. 8B is a cross-section according to BB in FIG. 6, for the fourth embodiment of the invention;

FIG. 9 is a perspective view of the first embodiment of the invention;

FIG. 10 is a diagram showing the fifth embodiment of the invention;

FIG. 11 is a diagrammatical side view of the fifth embodiment of the invention;

FIG. 12 is an enlarged view of the link between a structural floater and the structural element of the fifth embodiment of the invention;

FIG. 13 is a diagram showing the sixth embodiment of the invention;

FIG. 14 is a diagrammatical side view of the sixth embodiment of the invention; and

FIG. 15 is an enlarged view of the link between a structural floater and the structural element of the fifth embodiment of the invention. For increased clarity, identical or similar elements are marked with identical reference signs over all of the figures.

### DETAILED DESCRIPTION OF AN EMBODIMENT

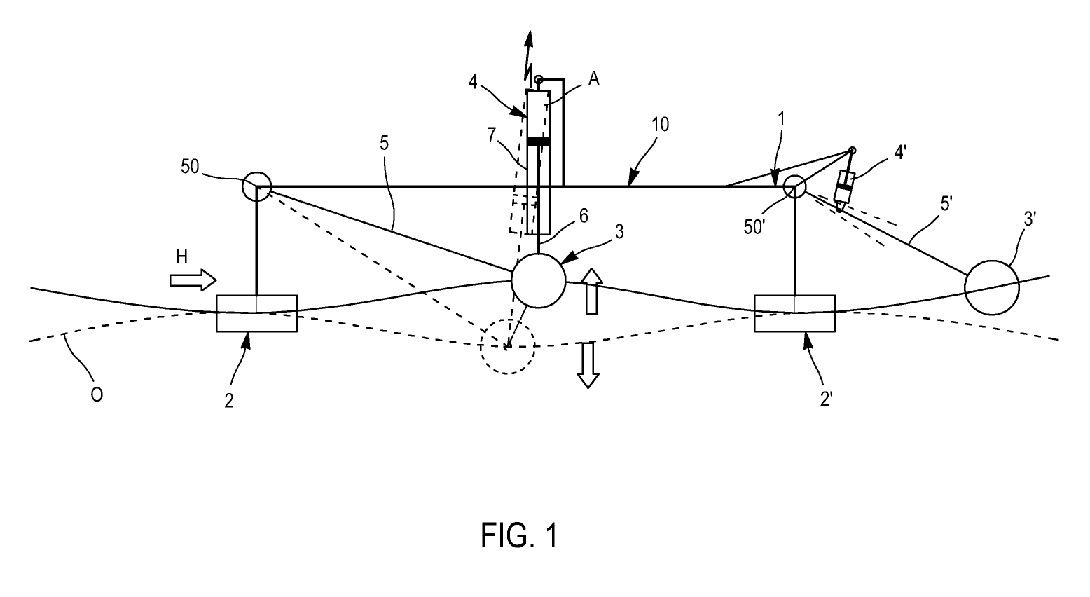

According to what is shown in FIG. 1, the invention comprises a structural element 1 that is rigid throughout, which floats on the sea 0 thanks to at least one buoy or floater referred to as structural 2.

The structural element can be comprised of beams which extend substantially parallel to the waves, and beams perpendicular to the latter; many solutions can be considered; supposing that the waves are oriented according to the arrow H, a separation between two structural floaters 2 2′ of a magnitude of one wavelength of a wave will be chosen more preferably, as shown in FIG. 1. This is a known arrangement which makes it possible to best recover the energy from the waves. According to the configuration shown, 2 is a front floater, while 2′ is a rear floater; with the terms “front” and “rear” referring to the direction of propagation of the waves.

Moreover at least one floater 3, 3′ is provided, mobile with regards to the structural element 1. The floater or floaters 3 cooperate with a means of generating energy 4 which can have various forms. In any case the means of generating energy 4 is fixed on the structural element 1.

Preferentially the mobile floater 3 is connected to the structural element 1 by at least one rigid arm 5 mounted rotatingly around an axis 50 substantially parallel to the surface of the sea. As such the mobile floater or floaters 3 are reliably connected to the structural element 1 and their relative movement with regards to the structural element 1 is perfectly integrated. The rigid arm or arms 5 guide and maintain the mobile floaters 3 with regards to the structural element.

By “arms” is meant any type of means of support such as one or several rods, apron, chains, etc.

Moreover the floater or each floater 3 is connected directly or indirectly to a means 4 of generating energy; more precisely according to FIG. 1 the floater 3 is connected to the cylinder 7 of a pump which comprises a rod 6 of a piston which slides in said cylinder 7 fixed on the structure and is used as a means of generating energy. Indeed under the effect of the movement of the waves, the piston slides in the cylinder and compresses or expands the fluid present inside the closed enclosure of the pump.

As such, the energy of the waves can be transmitted by pistons, cylinders, linear generators or any other technically equivalent means.

By dimensioning the device as shown in FIG. 1, the energy output thereof is optimised: more precisely, a separation is chosen between two structural floaters 2, 2′ substantially equal to an average length of a wavelength, and the means 4 is positioned substantially in the meddle of said length in such a way that the floaters 2, 2′ are for example in wave troughs (shown as a solid line in FIG. 1), the means 4 is located on a wave crest in such a way that the level of water in the closed enclosure of the pump is maximum, which generates the reduction in the volume A and therefore the compression of the fluid (air) present inside. This compression induces a recoverable energy. Then when the structural floater 3 is located in the trough of a wave (shown as a dotted line in FIG. 1), the level of the water descends again as well as the rod 6, in such a way that the pressure of the fluid in the enclosure A decreases. With such an arrangement relatively substantial piston travel and therefore optimised output is obtained.

Note that the wavelength of the waves is in general a known value and characteristic of a given location. The dimensioning of the device according to the invention will advantageously take this parameter into account.

It is understood that in a device such as described hereinabove, there is “top” dead centre and a “bottom” dead centre for which no energy is created; that is why this invention proposes to add at least one additional mobile floater 3′ associated with at least one means 4′ of generating energy.

The right portion of FIG. 1 diagrammatically shows the additional mobile floater 3′ connected by an additional rigid arm 5′ articulated on the structural element 1. Preferentially the rigid arm 5′ is mounted as the first rigid arm 5 i.e. rotating around an axis substantially parallel to the surface of the sea, with the point of articulation 50′ on the structural element 1 being here chosen at the end opposite the point of articulation 50 relative to the direction of propagation of the waves (arrow H).

An additional means 4′ of recovering energy is coupled to the floater 3′, here via the rigid arm 5′. The movement of the additional floater 3′ is as such used by the means 4′ for recovering energy, in the same way as explained hereinabove relative to the mobile floater 3. The distance between the two floaters 3, 3′ makes it possible to recover energy induced by the additional floater 3′ when the floater 3 is for example at the top dead centre or at the bottom dead centre, i.e. when it is does not produce energy.

Any suitable structure can be provided on the structural element 1 in order to support the additional means 3′, 4′, 5′ which have just been described.

Furthermore the rigid link and support arms 5, 5′ between a floater 3, 3′ and the structural element 1 have preferentially different lengths; a greater length can advantageously be chosen for the arm 5 arranged as close as possible to the entry of the waves on the device, and a lesser length for the arm 5′ located at the output of the device. “Entry” means the zone of the device which is affected by the waves before any other zone. The “output” is the zone placed at the other end of the structure relative to the direction of propagation of the waves.

As such the arm 5 and the associated floater 3, arranged at the entry of the device, are subjected to the strongest forces; while the additional arms 5′ and floaters 3′ are subjected to lesser forces as the energy of the wave has been weakened between these two points.

Moreover for an equal output the travel of the cylinders according to the invention is less than in prior art.

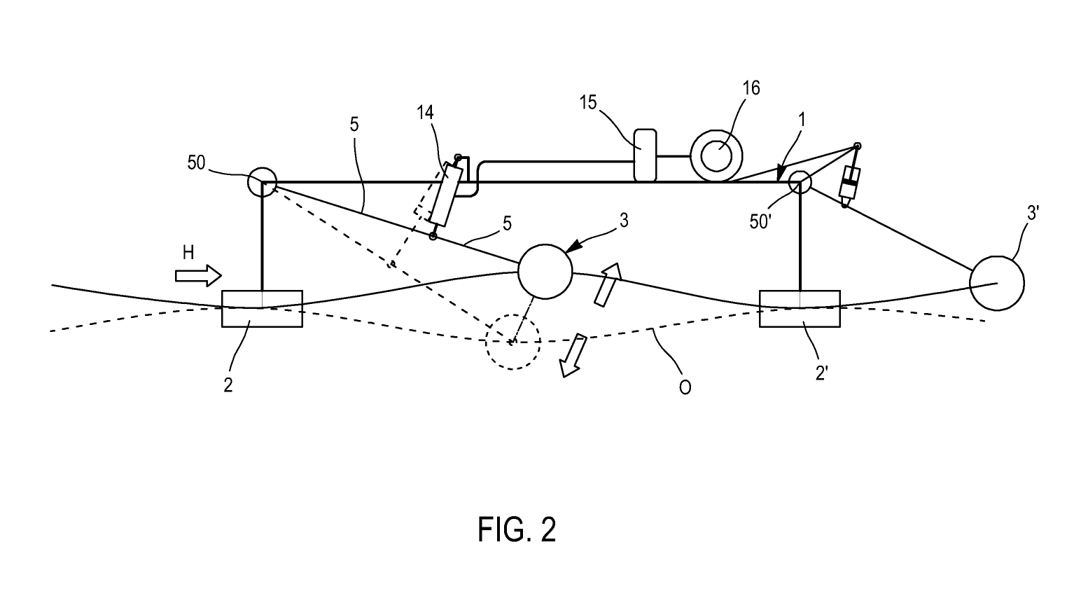

FIG. 2 shows an embodiment of the invention which differs from that in FIG. 1 substantially by the means of generating energy which here include a hydraulic pump 14 associated with an accumulator 15 and with a hydraulic motor 16 with a generator.

Those skilled in the art will choose one embodiment or the other according to need, costs, desired output, etc.

In both cases at least one buoy 2 or structural floater is provided, fixed with regards to the structural element 1 and arranged on the waterline. Any means known per se can be provided to carry out this floater function which therefore will not be discussed in any further detail.

The structural floater or floaters 2, 2′ therefore maintain the structure 1 at a given level with regards to the waterline; in addition they are subjected to the forces generated by the waves.

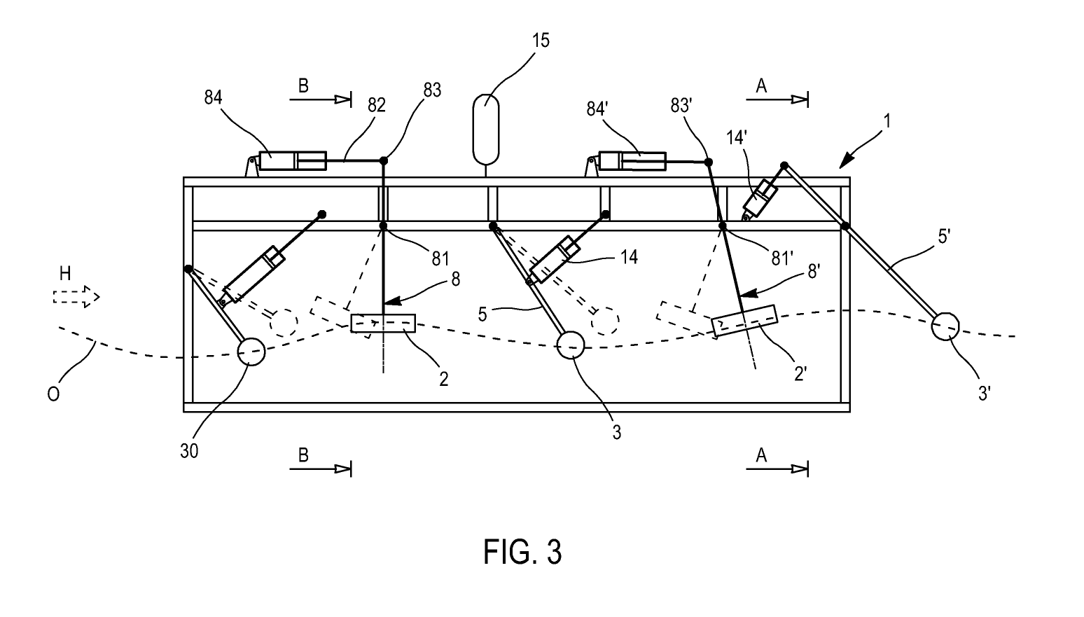

FIG. 3 shows an improved embodiment of the invention. The improvement consists in particular in providing at least one structural floater 2 articulated with regards to the structural element 1 (or framework).

According to this embodiment of the invention, the structural element 1 is partially immersed as shown in this figure.

Moreover at least one of the structural floaters 2 is connected by a swinging arm 8 linked to the structural element 1 via at least one first articulation 81 arranged above the waterline 0. The floater 2 itself can be placed substantially at the end of the swinging arm 8, and a first articulated link 81 is provided which cooperates with a second articulated end 83 itself connected with a cylinder 84, or more precisely with the rod 82 of the cylinder 84 fixed on the structural element 1. As such the arm or each arm 8 swings around the articulation 81 in a plane substantially perpendicular to the surface of the sea. The end 83 of the arm 8 opposite that bearing the floater 2 makes it possible to provide a movement of comings and goings to the cylinder 84 or to any other element for recovering energy, which then adds to the energy created by the movement of the mobile floater or floaters 3, 3″.

The cylinder 84 associated with the movement of the arm 8 allows for the production of energy, via for example an accumulator 15 or any other equivalent means such as an electric generator for example fixed on the structure, not far from the cylinder or cylinders 84.

From an energy standpoint, this embodiment is interesting as the energy supplied by the movement of the structural floaters 2, 2′ is added to that supplied by the movement of the mobile floater or floaters 3, 3′.

Of course according to need, several swinging floaters 2 can be mounted on the structure 1 which itself can have several alternative embodiments. FIG. 3 shows two structural floaters (or set of structural floaters) 2, 2′ but of course this is only a non-restricted example.

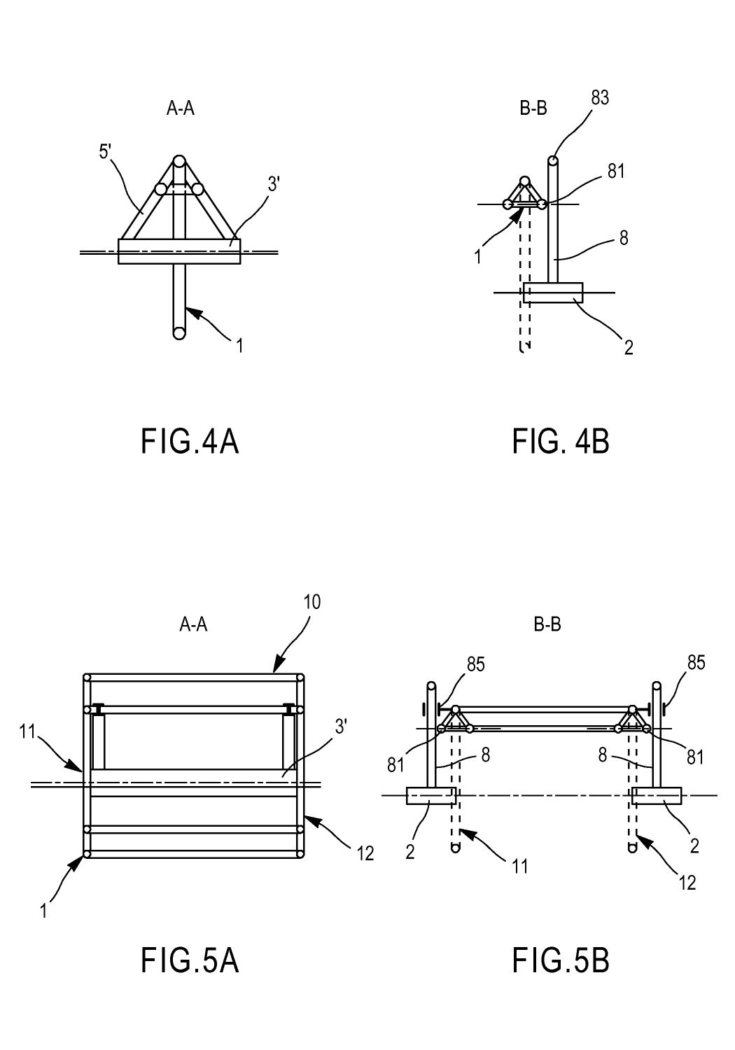

FIGS. 4A and 4B show an embodiment according to which the structure (or structural element) 1 consists of a framework substantially arranged according to an plane. The means of the invention such as the structural floater or floaters 2, 2′, the mobile floater or floaters 3, 3′ and the associated arms 8, 8′, 5, 5′ as well as the articulations and cylinders are here borne by such a framework. Those skilled in the art will choose and dimension the support elements and others according to their general knowledge.

FIG. 4A which is a simplified cross-section view according to AA in FIG. 3, shows a cylindrical mobile floater 3′ arranged at the end of a double arm 5′ articulated on the structure 1. FIG. 4B is a simplified cross-section view according to BB in FIG. 3, wherein a structural floater 2 is shown at the end of the bras 8 which is articulated and cooperates with the structure 1 on the articulation 81; the arm 8 is mobile in rotation around the articulation 81, in a single plane; its end 83 opposite that bearing the floater 2 cooperates with the rod 82 such as explained hereinabove.

Furthermore FIGS. 5A and 5B show via simplified cross-sections an embodiment of the invention according to which the structural element 1 comprises two first frameworks 11, 12 referred to as lateral respectively arranged according to a first and a second plane parallel to one another, and which are connected together by at least one framework (not referenced) referred to as transversal arranged according to a plane perpendicular to the first frameworks 11, 12. The unit defines as such a parallelogram of which a surface 10 is placed above the level of the sea and is provided with means of support for the various means that comprise the invention.

Furthermore on each of the lateral frameworks 11, 12 can be provided the articulations 81 for the arms 8 of the structural floaters 2, as well as means for guiding 85 for the upper ends of the arms 8 to which are associated the cylinders 84.

According to this embodiment, the energy is therefore supplied by the movement of the mobile floaters 3, 3′ which, being separated from each other, allow for a regulation of the power of the energy supplied, as well as by the movement of the structural floaters 2, 2′ of which the spacing relative to the direction of the waves allows and improves the regulation of the power of the energy supplied.

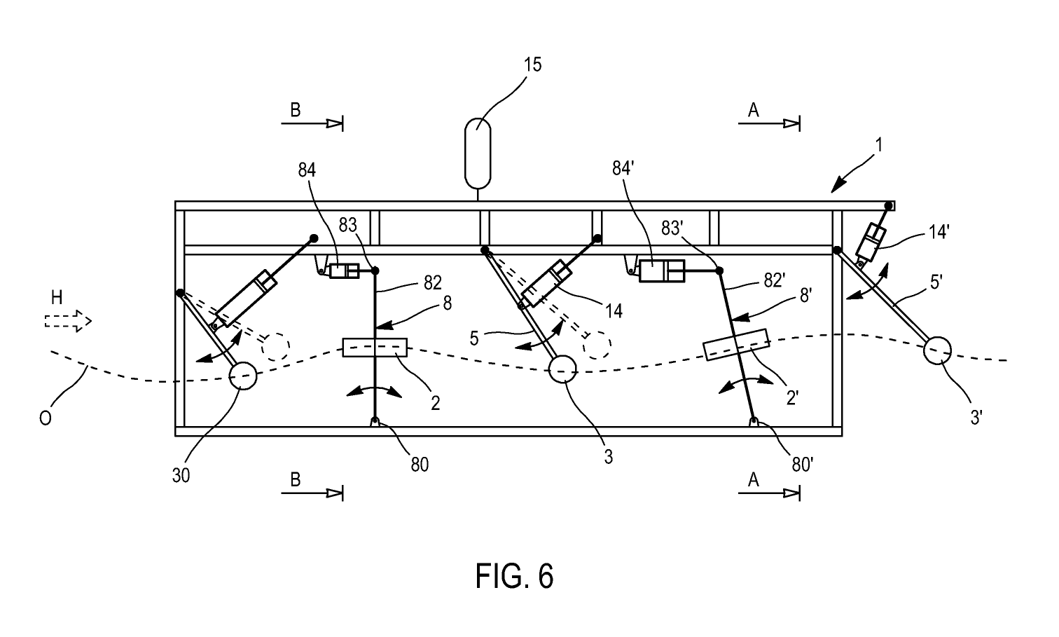

According to an alternative embodiment illustrated in FIGS. 6, 7 and 8 at least one of the structural floaters 2 is passed through by a swinging arm 8 linked to the structural element 1 by a first articulation 80 arranged below the waterline. The link 80 is more preferably a link of the pivot type; the floater 2 in itself can be placed substantially in the middle of the swinging arm 8; near the end opposite the arm 8 bearing the pivot link 80, an articulated link 81 is provided with a cylinder 84, or more precisely with the rod 82 of the cylinder 84 which itself is fixed on the structural element 1. The end in itself of the arm 8 is guided in a suitable groove of the structural element 1.

As such the arm or each arm 8 swings in a plane around the articulation 80 (as indicated by the arrows), and the opposite end thereof makes it possible to provide a movement of comings and goings to a cylinder or any other element for recovering energy, which is then added to the energy created by the movement of the mobile floater or floaters 2, 2′.

The cylinder 84 associated with the movement of an arm 8 allows for the production of energy, via for example an accumulator or any other equivalent means such as an electric generator.

From an energy standpoint, this embodiment is interesting as the energy supplied by the movement of the structural floaters is added to that supplied by the movement of the mobile floater or floaters 3, 3′.

Of course according to needs, several swinging floaters 2, 2′ can be mounted on the structure 1 which itself can have several alternative embodiments.

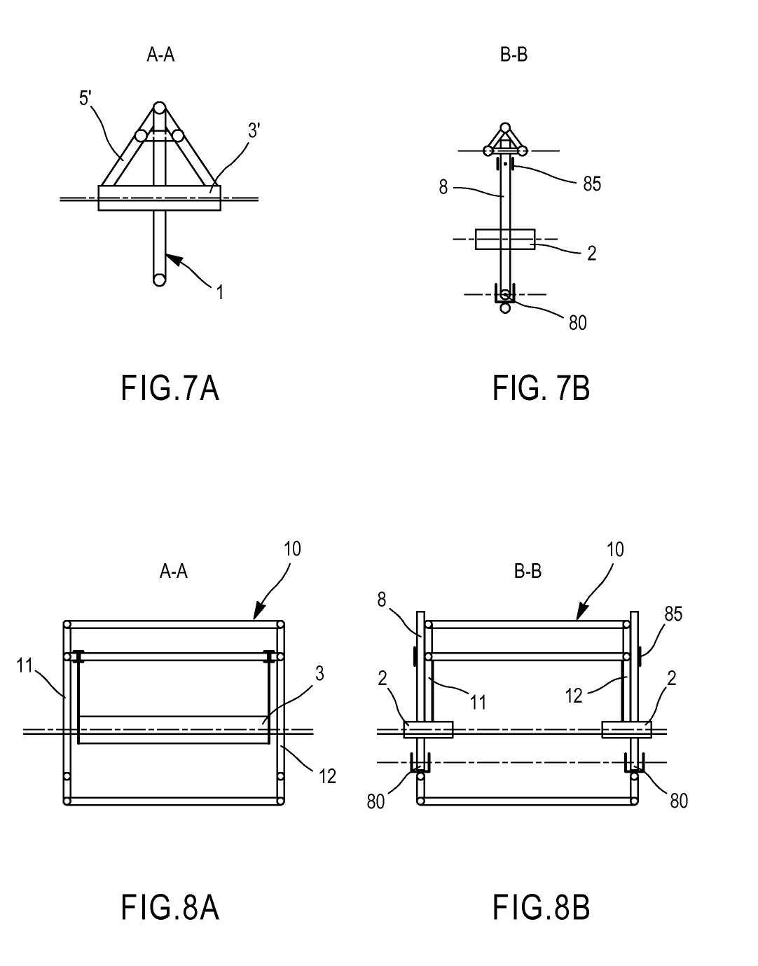

As such FIGS. 7A and 7B show an embodiment according to which the structure (or structural element) consists of a framework substantially arranged according to a plane. The means of the invention such as the structural floater or floaters 2, 2′, the mobile floater or floaters 3, 3′ and the associated arms 8, 8′, 5, 5′ as well as the articulations and cylinders are here borne by such a framework which extends substantially according to a plane. Those skilled in the art will choose and dimension the support elements and others according to their general knowledge.

The arms 5, 5′ can have the same length or not.

Furthermore FIGS. 8A and 8B show via simplified cross-sections an embodiment of the invention corresponding to the embodiment of the FIG. 6 according to which the structural element 1 comprises two first frameworks 11, 12 referred to as lateral arranged according to a first and a second plan, and are connected together by at least one framework (not referenced) referred to as transversal arranged according to a plane perpendicular to the first frameworks 11, 12. The unit defines as such a parallelogram of which a surface 10 is placed above the level of the sea and is provided with means of support for the various means that comprise the invention (not shown in FIGS. 8A and 8B).

Furthermore on each of the lateral frameworks 11, 12 can be provided articulations of the pivot type 80, 80′ for the structural floaters 2, 2′, as well as guides 85 for the upper ends of the arms 8, 8′, and of the associated cylinders 84.

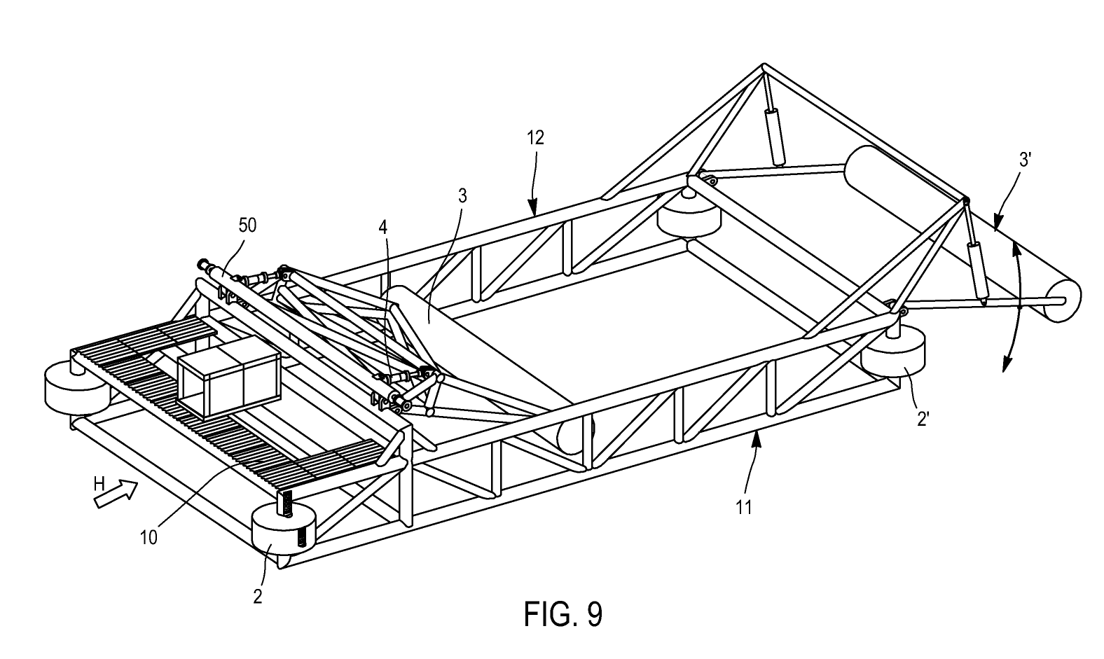

FIG. 9 shows an embodiment of the invention having a structural element of a general parallelepiped shape, and comprising two mobile floaters 3, 3′ and four structural floaters 2, 2′ fixed with regards to the structural element 1. This view corresponds substantially to the embodiment of the invention according to FIG. 1.

According to this embodiment, the energy is therefore supplied solely by the movement of the mobile floaters 3, 3′ which, being separated from each other, allow for a regulation over time of the power of the energy supplied.

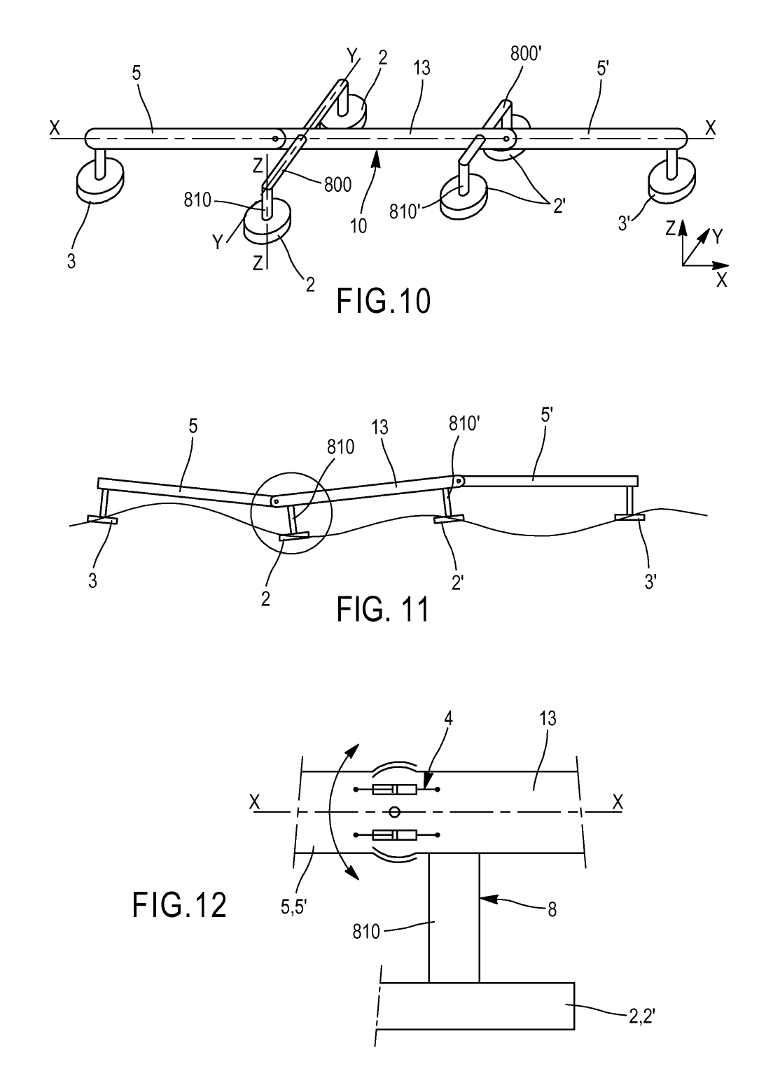

FIG. 10 shows an embodiment of the invention according to which the device comprises a structural element 10 in particular comprised of an element referred to as main 13 which extends according to a longitudinal axis XX. This main element 13 can be comprised of a platform whereon are fixed or arranged various components, connections or tools required for the operation of the device; in particular the means 4, 4′ for recovering energy.

At least one of the longitudinal ends of the main element 13 is mounted articulated, for example via a pivot link, a rigid arm 5, 5′; interestingly the rigid arm or arms 5, 5′ are arranged deployed outside of the structural element 1. FIGS. 10 and 11 show a main element 13 of which each longitudinal end is provided with an articulated link with a rigid arm 5, 5′. The rigid arms can have the same length or be of a different length. Each rigid arm 5, 5′ bears at least one mobile floater 3, 3′ such as defined hereinabove. The articulated link is more specifically shown in FIG. 12 where it can be seen that on the end of the main element 13 are furthermore arranged means 4 for recovering energy due to the relative movement of the element 13 and of the arm 5.

Additional rigid arms can furthermore be provided, articulated at the distal ends of the rigid arms 5, 5′ such as can be seen in FIG. 10 and following. A sort of chain formed of arms articulated at their respective ends can as such be formed.

On different articulations, the seal (relative as these articulations are arranged above the sea) is provided by the covering with contact of the ends of the arms 13, 5, 5′. It is substantially cylindrical walls which are covered as such.

Likewise each comprising element inside the main element 13 is sealed itself, in a manner known per se.

Without leaving the scope of the invention the structural element can include several elements 13 referentially arranged in the extension of one another according to the longitudinal axis XX; the elements 13 can be articulated between each other via pivot links.

Moreover the main structural element 13 is borne (in floating situation) by at least one structural floater 2, 2′ arranged symmetrically with regards to the longitudinal axis XX. FIGS. 10 and 11 show two pairs of floaters 2, 2′; each floater 2, 2′ is arranged at the end of an arm 800, 810 belonging to a plane perpendicular to the axis XX; more precisely according to this embodiment of the invention each arm is comprised of a first element 800, 800′ which extends substantially parallel to the surface of the sea and of a second element 810, 810′ which extends perpendicularly or substantially perpendicularly to the first element. A floater is arranged at each end of the second element 810, 810′. A symmetrical structure with regards to the longitudinal axis XX is as such formed. Each first element 800, 800′ extends substantially according to an axis YY perpendicular to the axis XX.

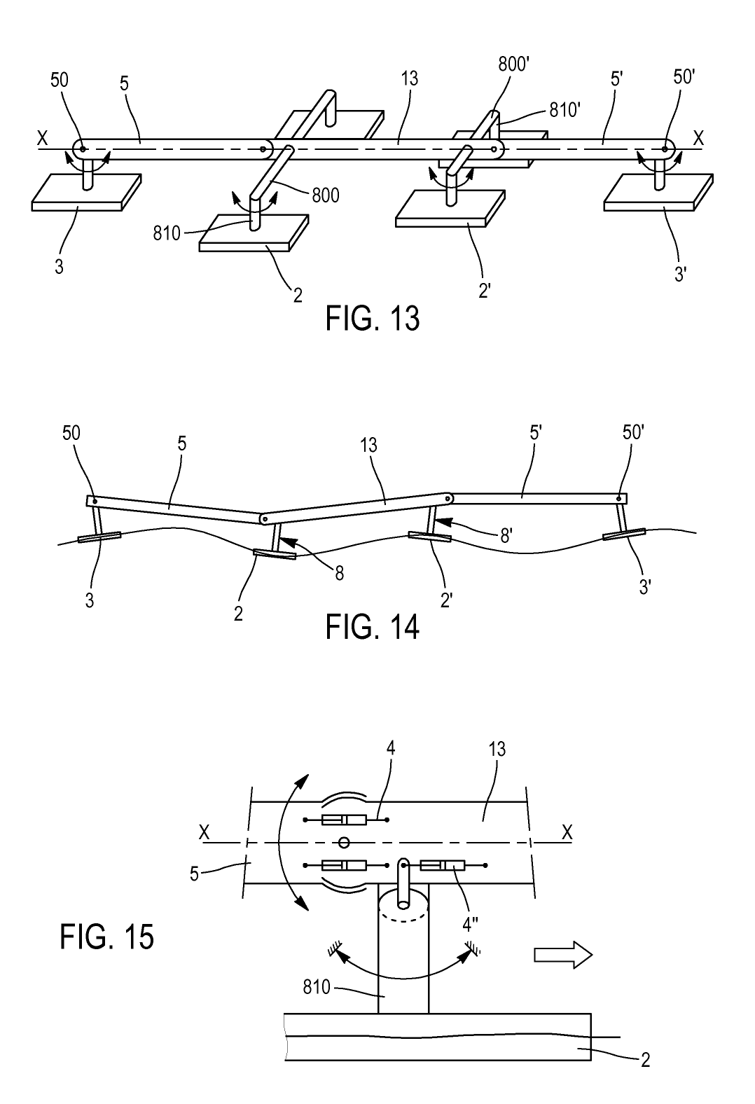

FIGS. 13 to 15 show an embodiment which differs from the one exposed in relation with FIGS. 10 to 12 in that there is an additional articulated link between the structural element 13 and at least one structural arm 800, 810. This link makes it possible for the structural floaters 2, 2′ to better follow the movement of the waves H; furthermore the energy created by the relative movement between each structural arm 800, 810 and the structural element 13 itself can be recovered by a specific means 4″ as can be seen in FIG. 15. Likewise the floaters 3, 3′ can be linked to the rigid arms 5, 5′ via an articulated link.

Of course the shape and the dimensions of the floaters shall be chosen by those skilled in the art and adapted to the conditions of use. Likewise the dimensions of the rigid arms 5, 5′ in particular are determined according to the uses and the installation locations. The arms 5, 5′, when they are comprised of solid cylindrical walls, can have diameters of a few metres in such a way that a man can move about inside; the length thereof can reach several tens of metres.

Without leaving the scope of the invention the rigid arms 5, 5′ as well as the structural arms 13, 800, 800′ can be comprised of non-solid walls, for example will a grill.

Each portion of the structure can be insulated electrically, partially or totally, in order to provide safety for users.

This invention makes it possible to recover the energy linked to the height of the waves as well as to their inclination: a single electric circuit can be provided, or several. The recovering of the energy can be obtained with a single system or several.

A volume required for the maintenance operations is as such created in the system according to this invention.

Many combinations can be considered without leaving the scope of the invention; those skilled in the art will choose one or the other according to the economic, ergonomic, dimensional or other constraints that must be complied with.

1. A device for recovering the energy of sea waves comprised of a floating structure comprising:
a rigid structural element maintained floating on the sea thanks to at least one buoy or floater referred to as structural, and
at least one mobile floater with regards to the structural element and cooperating with a means of generating recoverable energy under the effect of the movement of the waves, said means of generating energy being fixed on the structural element characterised in that the at least one mobile floater is connected to the structural element by at least one rigid arm mounted rotatingly around an axis substantially parallel to the surface of the sea and in that said means of generating energy is linked directly or indirectly to said rigid arm.

2. The device for recovering energy according to claim 1 characterised in that the means of generating energy comprises a linear generator having a piston linked to at least one of said mobile floaters, and which slides in a cylinder linked to the structural element.

3. The device for recovering energy according to claim 1 characterised in that the means of generating energy comprises at least one pump having a cylinder and a rod, of which one end is articulated on a rigid arm of at least one of said mobile floaters, and of which the other end is linked to the structural element.

4. The device for recovering energy according to claim 1, further including several mobile floaters of which the link arms with the structural element have different lengths.

5. The device for recovering energy according to claim 1, wherein the at least one structural floater is fixed in relation to the structural element, arranged on the waterline in such a way that the structural element is mostly arranged above the waterline.

6. The device for recovering energy according to claim 1, wherein the at least one structural floater is articulated in relation to the structural element.

7. The device for recovering energy according to claim 6, wherein the at least one of said articulated structural floaters is arranged at one of the ends of a swinging arm linked to the structural element by at least one first articulation, said arm having at its other end a second articulation associated with the rod of a piston of a cylinder fixed on the structural element above the waterline, said piston being intended to actuate said means of generating energy.

8. The device for recovering energy according to claim 7, wherein the at least one of said articulated structural floaters is passed through by a swinging arm linked to the structural element by two articulations the first arranged below the waterline consists of a pivot link, the second link comprises an articulation associated with the rod of a piston of a cylinder fixed on the structural element above the waterline, said piston being intended to actuate said means of generating energy.

9. The device for recovering energy according to claim 1, wherein the structural element comprises at least one framework arranged according to a plane referred to as lateral and which supports at least one structural floater and a mobile floater.

10. The device for recovering energy according to claim 1, wherein the structural element comprises two frameworks arranged according to a first and a second planes parallel to each other, said frameworks being connected together by at least one framework arranged according to at least one plane perpendicular to said first and second planes, with the whole defining substantially a parallelogram of which a surface arranged above the level of the sea is provided with means of support for the articulation or articulations, of the mobile floater or floaters and/or of the means of generating energy and/or of the structural floaters.

11. The device for recovering energy according to claim 1, wherein at least one first rigid arm is mounted articulated on a first longitudinal end of the structural element and in that a second rigid arm is mounted articulated on a second longitudinal end of the structural element, said first and said second arms extending longitudinally outside of the structural element.

12. The device for recovering energy according to claim 1, wherein the structural element comprises a main element which extends according to a longitudinal axis XX, in that said structural floaters are arranged symmetrically with regards to the axis XX and in that at least one first and a second structural floaters bear, in floating situation, structural arms belonging to a plan perpendicular or substantially perpendicular to the axis XX.

13. The device according to claim 12 characterised in that at least one structural arm is mounted rotatingly around an axis YY perpendicular to the axis XX.

14. The device according to claim 12, wherein the at least one structural arm comprises a first element which extends substantially parallel to the surface of the sea, and a second element which extends substantially perpendicularly to the first element and which bears a structural floater.

15. The device according to claim 12, wherein a rotating link is provided between the main element and at least one structural arm.

16. The device according to claim 12, wherein a rotating link is provided between the first and the second element of a structural arm and in that at least one means of generating energy makes it possible to recover the energy generated by the relative movement of the first and of the second element.
